(19) United States
(12) Patent Application Publication
(10) Pub. No.: US 2005/0092026 A1
(43) Pub. Date: May 5, 2005

(54) Curved support fixtures for shape control

(76) Inventors: Janice E. Merola, Painted Post, NY (US); Robert W. Pfitzenmaier, Canisteo, NY (US); Brian P. Strines, Painted Post, NY (US)

Correspondence Address: WALL MARJAMA & BILINSKI, 101 SOUTH SALINA STREET, SUITE 400, SYRACUSE, NY, 13202, US

(21) Appl. No.: 10/700,172

(22) Filed: Nov. 3, 2003

(51) Int. Cl. C03B 23/025

(52) U.S. Cl. 65/107; 65/287

(57) ABSTRACT

The present invention is directed to a method for producing at least one glass substrate having a predetermined shape. The method includes providing a processing fixture configured to support the at least one glass substrate. The processing fixture includes at least one curved support member having a predetermined curvature. The at least one glass substrate is placed on the at least one curved support member. The at least one glass substrate is heated to a predetermined temperature for a predetermined period of time. The predetermined temperature is below the glass softening point and sufficiently high enough to cause glass shape change, whereby the at least one glass substrate conforms to the predetermined curvature during the predetermined period of time.

### BACKGROUND OF THE INVENTION

1. Field of the Invention

The present invention relates generally to display glass substrates, and particularly to a method for providing a glass substrate having a predetermined shape.

2. Technical Background

In the current manufacturing process of Active Matrix Liquid Crystal Display (AMLCD) substrates, individual glass substrates are typically transferred, stored and transported in a horizontal configuration. Substrates may be formed by several techniques—one of the techniques is known as overflow “downdraw.” This technology is described in U.S. Pat. No. 3,338,696 (Dockerty) and U.S. Pat. No. 3,682,609 (Dockerty), and is one of the few processes capable of delivering display substrate glass without requiring costly post substrate forming finishing operations, such as lapping and polishing.

These display substrates are incorporated into a variety of products including computer monitors, televisions, and numerous hand-held electronic devices such as PDAs and cellular phones.

Currently, there is a demand for larger and larger display sizes. This demand, and the benefits derived from economies of scale, is driving AMLCD manufacturers to process larger display substrates. In addition, there is also a demand for lighter and thinner displays. Unfortunately, this combination makes processing of glass in today's manufacturing lines more difficult—as the substrate size is increased and the glass thickness is decreased, the elastic sag of the glass substrate becomes a problem.

One origin of this sag can be understood by referring to FIG. 1 which shows how glass substrates are transported between each work station in cassettes. The loading and unloading of cassettes at each station are performed by robotics. Thinner and/or larger substrates result in larger sag, making it more difficult for the end effecter to load and unload the substrates into and from the cassettes. FIG. 2 shows the sag characteristics of conventional glass substrates within a cassette.

Contact between the glass sheet held by the end effecter and glass in the cassette can result in breakage, causing the manufacturer to lose the substrate product. This also causes an interruption of the manufacturing process and loss of production time. Other substrates in the cassette may also be lost due to surface contamination or damage from pieces of the broken substrate.

Another glass attribute of interest to the customer is thermal stability wherein a substrate maintains, as much as possible, its original length and width. Thermal processing at the manufacturer can compact (i.e. densify) a substrate and thereby reduce the original dimensions through subtle shrinkage. Greater thermal stability can be achieved by compacting the glass before shipment to the manufacturer. So, what is also achievable is a glass substrate that has increased thermal stability in the customers' manufacturing processes.

Accordingly, it is desirable to provide a substrate product that has thermal stability, and consistent and predictable sag characteristics.

### SUMMARY OF THE INVENTION

The present invention addresses the aforementioned needs. The present invention provides a substrate product that has smaller, consistent, and predictable sag characteristics. Further, the glass substrate of the present invention exhibits increased thermal stability.

One aspect of the present invention is a method for producing at least one glass substrate having a predetermined shape. The method includes providing a processing fixture including at least one curved support member having a predetermined curvature. The at least one curved support member is configured to support the at least one glass substrate. The at least one glass substrate is placed on the at least one curved support member. The at least one glass substrate is heated to a predetermined temperature for a predetermined period of time. The predetermined temperature is below the glass softening point and sufficiently high enough to cause glass shape change, and possibly compaction, whereby the at least one glass substrate conforms to a predetermined curvature during the predetermined period of time, and may or may not experience compaction.

In another aspect, the present invention includes an apparatus for producing at least one glass substrate having a predetermined shape. The apparatus includes a processing fixture including at least one curved support member having a predetermined curvature. The at least one curved support member is configured to support the at least one glass substrate. A furnace is configured to heat the at least one glass substrate to a predetermined temperature for a predetermined period of time. The predetermined temperature is below the glass softening point and sufficiently high enough to cause glass compaction, whereby the at least one glass substrate conforms to the predetermined curvature during the predetermined period of time.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operation of the invention.

### BRIEF DESCRIPTION OF THE DRAWINGS

FIG. 1 is a perspective view of the cassettes used to transport glass substrates;

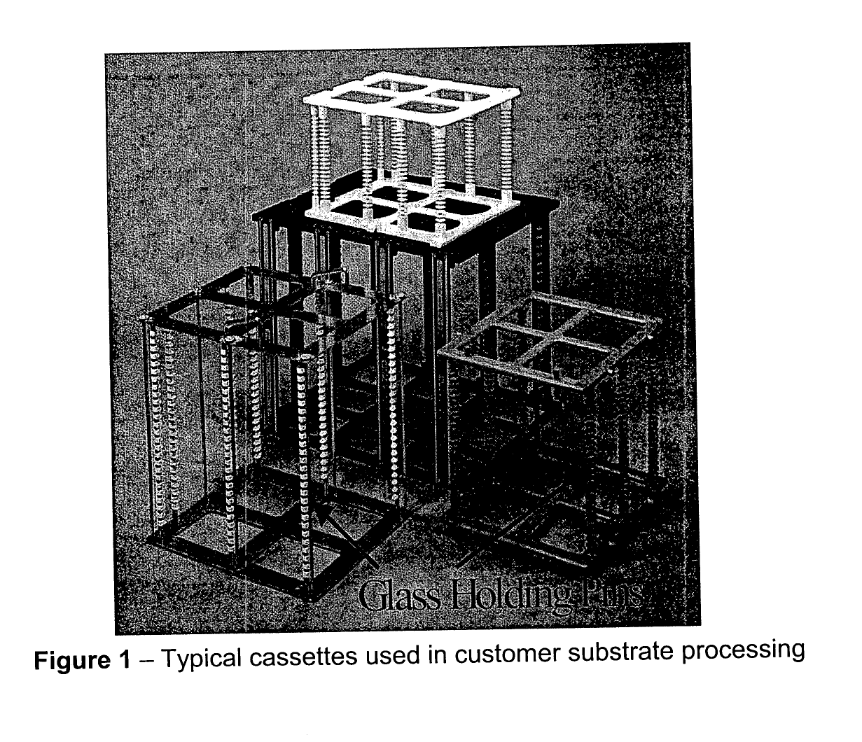

FIG. 2 is a diagrammatic depiction of the sag characteristics of conventional glass substrates within a cassette;

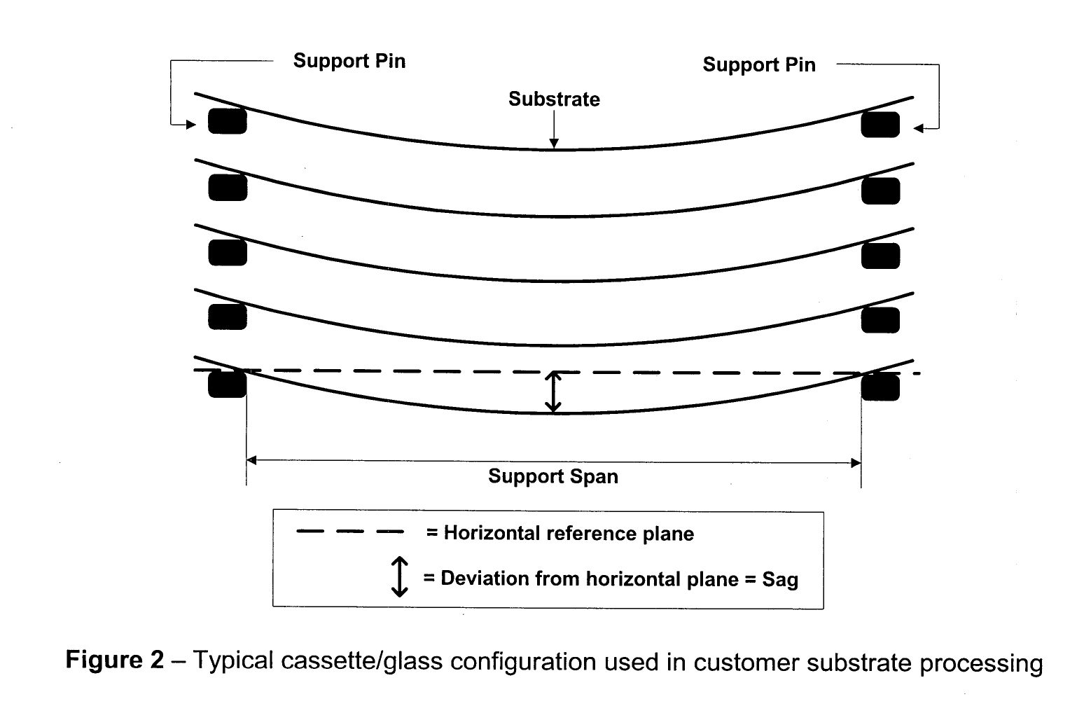

FIGS. 3A and 3B are open and closed views, respectively, of the processing fixture in accordance with the present invention;

FIG. 4 is a diagram comparing the sag characteristics of each side of a glass substrate fabricated in accordance with the present invention relative to zero-gravity reference levels; and

FIG. 5 is a diagram comparing the sag characteristics of each side of glass substrate fabricated in accordance with the present invention.

### DETAILED DESCRIPTION

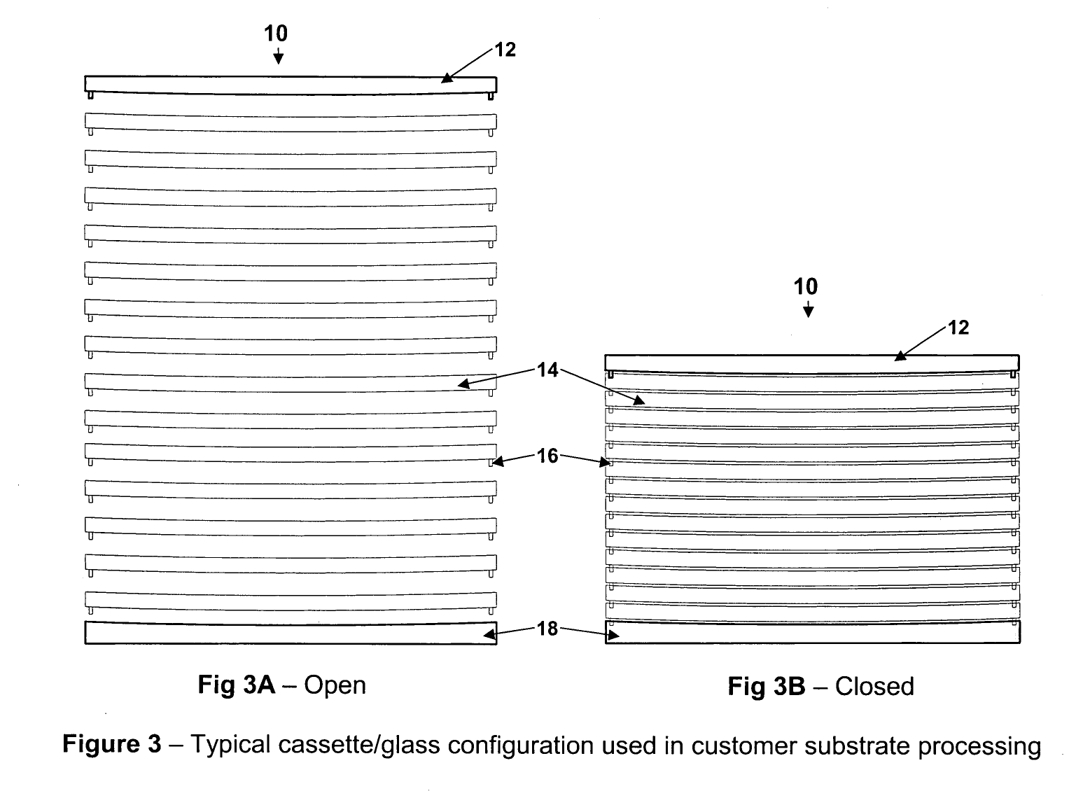

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the processing fixture of the present invention is shown in FIGS. 3A and 3B, and is designated generally throughout by reference numeral 10.

In accordance with the invention, the present invention is directed to a method and apparatus for producing glass substrates having a predetermined shape. The apparatus includes a processing fixture configured to hold the glass substrates. The processing fixture includes at least one curved support member having a predetermined curvature. A furnace is configured to heat the at least one glass substrate to a predetermined temperature for a predetermined period of time. The predetermined temperature is below the glass softening point and sufficiently high enough to cause glass shape change, whereby the at least one glass substrate conforms to the predetermined curvature during the predetermined period of time. Thus, the present invention provides a substrate product that has smaller, consistent, and predictable sag characteristics. By further control of the thermal treatment, compaction can occur, resulting in glass substrates with increased thermal stability.

As embodied herein, and depicted in FIG. 3A, a view of the open processing fixture 10 in accordance with the present invention is disclosed. Fixture 10 includes convex end cap 12 which contacts curved support member 14 by adjustable alignment pins 16. Subsequent support members 14 also contact adjacent support members 14 by alignment pins 16. Finally, the last support member 14 contacts concave end cap 18. FIG. 3A shows fixture 10 in an open configuration that is suitable for loading the glass substrates. Initially, the first substrate to be loaded is placed on the curved surface of end cap 18. Subsequently, a support member 14 is placed over the glass substrate. This process continues until convex end cap 12 is placed over the last substrate to be loaded into fixture 10. After loading, fixture 10 is rotated 90°.

FIG. 3B is a closed view of fixture 10 as disposed in a suitable furnace. In practice, a temperature range between 400° C. and 700° C. is used. Depending on the temperature, the glass is heated for a time period of up to two hours. The heating causes a molecular structural rearrangement of the glass and the glass conforms to the shape of curved support members 14. While in fixture 10, the substrates are not firmly held or molded by the curved supports 14. Nonetheless a preferential shape is imparted, and a slight bow is formed in the substrate. With the aforementioned thermal conditioning, the imparted shape may be retained. The processed substrates have greater shape consistency and improved sag characteristics. The benefit of remaining loosely held, yet constrained, is that the desired shape can be created while allowing for thermal expansions and contractions to occur without glass breakage. A further benefit comes from the bowed shape during processing, whereby the substrates are somewhat self-supporting and less susceptible to gravity effects.

As depicted in FIG. 3, in one embodiment of the invention, the edges of curved support members 14 follow an arc of a circle of a predetermined radius. However, the present invention is not limited to arcuate support members. In another embodiment, non-arcuate curves, having compound radii, are used to achieve a predetermined shape. The radius is selected to provide a maximum deformation in support member 14 of up to 2 mm.

It will be apparent to those of ordinary skill in the pertinent art that modifications and variations can be made to curved support members 14 of the present invention depending on the thermal stability of the material. For example, curved support members 14 may be fabricated by machining a block of steel. A ceramic material may be used as well. However, curved support members 14 may be fabricated from any number of materials. First, the material must be readily machined or formed. Second, since cleanliness of the glass surface must be maintained, it must be non-friable. Third, the material must be relatively inert; it must not react or change the composition of the glass substrate in any way. Integrity of the glass surface is highly important, so chemical or physical interactions with the glass must not occur. Finally, the material must be thermally stable at process temperatures. There are other less critical considerations as well. The thermal expansion coefficient of the material should ideally be close to that of the glass. However, since the substrates are loosely held, this is not critical.

Sag variability is reduced by creating a consistent and intentional shape in the glass substrates. By constraining the shape of the substrates with the curved fixtures, the subsequent thermal processing will stress-relieve and anneal the substrates into the desired shape. Consequently, if a population of substrates exhibits shape variability, processing with curved fixtures will reduce the exhibited shape variability, and the variation in the amount of sag observed in a population of substrates will decrease. The overall magnitude of the sag observed in individual substrates is also reduced, and is accomplished through selective orientation of the bowed shape. In other words, during customer processing and cassette transport, the concave side of the bowed substrate is oriented downward.

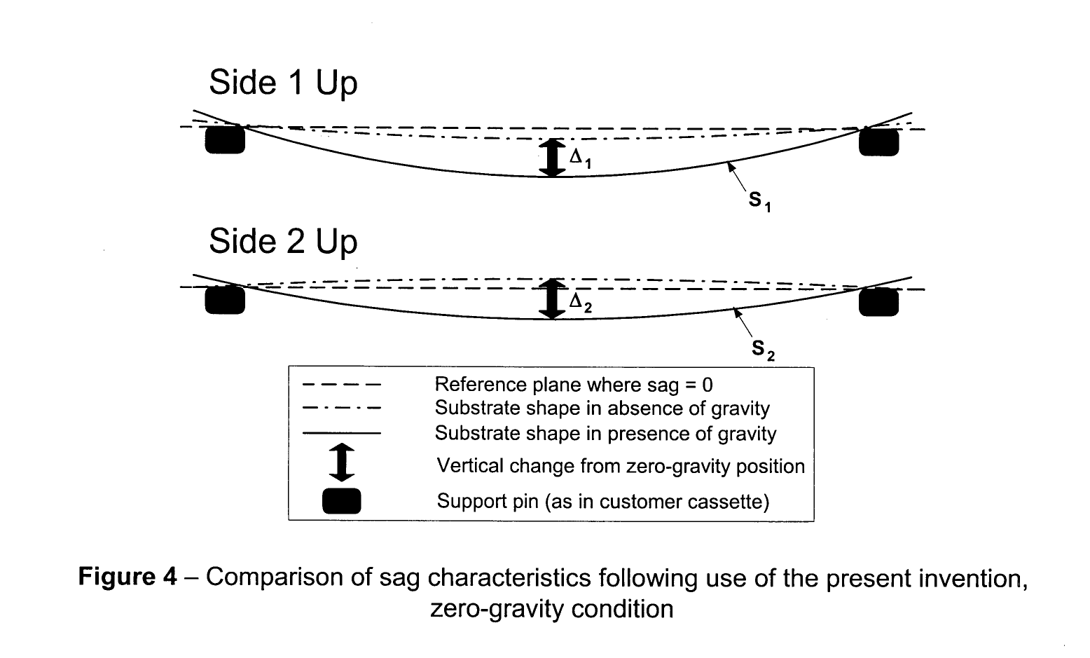

Referring to FIG. 4, a diagram comparing the sag characteristics of each side of a glass substrate fabricated in accordance with the present invention relative to zero-gravity reference levels is disclosed. Referring to Side 1, S₀₁ refers to the shape of the glass substrate when the concave side of the bowed substrate is oriented upward under zero gravity conditions. S₁ refers to the shape of the glass substrate when the concave side of the bowed substrate is oriented upward under normal conditions typically encountered on earth. Δ₁ refers to the maximum sag from the zero gravity position. Referring to Side 2, S₀₂ refers to the shape of the glass substrate when the concave side of the bowed substrate is oriented downward under zero gravity conditions. S₂ refers to the shape of the glass substrate when the concave side of the bowed substrate is oriented upward under normal conditions typically encountered on earth. Δ₂ refers to the maximum sag from the zero gravity position. Comparing side 1 to side 2, it is seen that Δ₁≈Δ₂, that is, the distance between the zero gravity position and the final resting position of the sagged substrate is essentially equivalent, regardless of which side is facing upward. Referring to Side 2, it is noted that the maximum deformation of the concave bow is the maximum distance between line S₀₂ and the horizontal reference. This distance is typically on the order of approximately 1 mm. Changing the reference to the zero sag plane (horizontal reference) gives us the case from which sag values are derived.

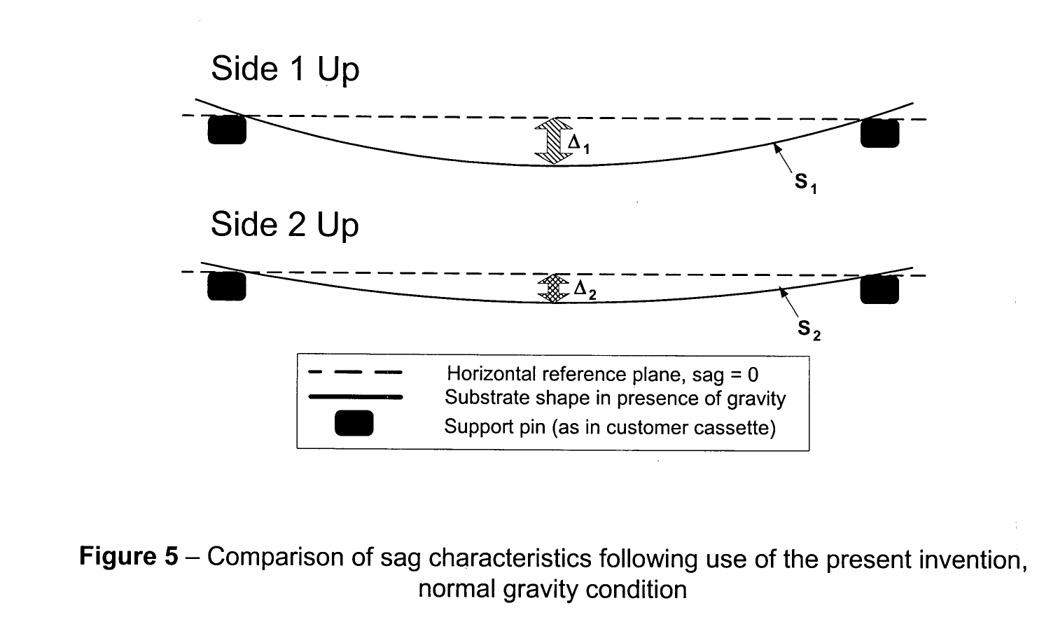

FIG. 5 compares the sag characteristics as measured from the zero sag plane (horizontal reference) for each side of a glass substrate fabricated in accordance with the present invention. FIG. 5 is a diagram that is very similar to FIG. 4. Again, S₁ refers to the shape of the glass substrate when the concave side of the bowed substrate is oriented upward under normal conditions, whereas S₂ refers to the shape of the glass substrate when the concave side of the bowed substrate is oriented upward. However, in this diagram Δ₁ refers to the maximum sag of side 1 from the horizontal and Δ₂ refers to the maximum sag of side 2 from the horizontal. As expected, Δ₁>Δ₂. Thus, for a bowed substrate, the amount of sag will be reduced when the concave side of the substrate is oriented downward. The concave side down orientation is the preferred orientation in a cassette. Thus, the benefits of the present invention are manifest. The induced shape change directly decreases the sag maxima. By imparting the shape change to the substrate, the substrate is provided a consistent shape that results in decreased sag variability from substrate to substrate.

As noted above, the improved shape consistency made possible by the present invention benefits all manufacturing processes, not just transport into and out of cassettes.

### EXAMPLE

The invention will be further clarified by the following example which is intended to be exemplary of the invention. In the example, a column chart depicts a decrease in substrate sag made possible through use of the present invention.

[image]

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A method for producing at least one glass substrate having a predetermined shape, the method comprising:
providing a processing fixture including at least one curved support member having a predetermined curvature, the at least one curved support member being configured to support the at least one glass substrate;
placing the at least one glass substrate on the at least one curved support member; and
heating the at least one glass substrate to a predetermined temperature for a predetermined period of time, the predetermined temperature being below the glass softening point and sufficiently high enough to cause glass shape change, whereby the at least one glass substrate conforms to the predetermined curvature during the predetermined period of time.

2. The method of claim 1, wherein the processing fixture includes a plurality of curved support members.

3. The method of claim 1, wherein the processing fixture includes a plurality of curved support members for accommodating a plurality of glass substrates.

4. The method of claim 1, wherein the predetermined temperature is within a range of temperatures between 400-700° C.

5. The method of claim 1, wherein the predetermined period of time is within a range of up to several hours.

6. The method of claim 5, wherein the predetermined period of time is approximately one hour.

7. The method of claim 1, further comprising the step of cooling the at least one glass substrate, whereby the at least one glass substrate retains the predetermined curvature.

8. The method of claim 1, wherein the step of providing includes fabricating the at least one curved support member from a relatively inert material that does not interact with or contaminate the at least one glass substrate at the predetermined temperature.

9. An apparatus for producing at least one glass substrate having a predetermined shape, the apparatus comprising:
a processing fixture including at least one curved support member having a predetermined curvature, the at least one curved support member being configured to support the at least one glass substrate; and
a furnace configured to heat the at least one glass substrate to a predetermined temperature for a predetermined period of time, the predetermined temperature being below the glass softening point and sufficiently high enough to cause glass compaction, whereby the at least one glass substrate conforms to the predetermined curvature during the predetermined period.

10. The apparatus of claim 9, wherein the at least one curved support member is fabricated from a relatively inert material that does not interact with or contaminate the at least one glass substrate when disposed in an environment having an ambient temperature that is less than or equal to 700° C.

11. The apparatus of claim 10, wherein the material includes steel.

12. The apparatus of claim 10, wherein the material is a ceramic material.

13. The apparatus of claim 10, wherein the at least one curved support member includes a plurality of curved support members, each of the plurality of curved support members accommodating one glass substrate.

14. The apparatus of claim 13, wherein the processing fixture further comprises a plurality of alignment elements disposed between adjacent curved support members.

15. The apparatus of claim 14, wherein the plurality of alignment elements are adjustable such that the plurality of curved support members is movable between an open position and a closed position.
